(19) United States
(12) Patent Application Publication
(10) Pub. No.: US 2019/0014121 A1
(43) Pub. Date: Jan. 10, 2019

(54) INFORMATION PROCESSING SYSTEM, INFORMATION PROCESSING APPARATUS, AND NON-TRANSITORY COMPUTER READABLE MEDIUM

(71) Applicant: FUJI XEROX CO., LTD., Tokyo (JP)

(72) Inventor: Takashi NAKAMURA, Kanagawa (JP)

(73) Assignee: FUJI XEROX CO., LTD., Tokyo (JP)

(21) Appl. No.: 16/015,899

(22) Filed: Jun. 22, 2018

(30) Foreign Application Priority Data
Jul. 6, 2017 (JP) 2017-132937

(51) Int. Cl. H04L 29/06; G06N 3/08

(52) U.S. Cl. CPC H04L 63/105; G06N 3/08; H04L 63/16; H04L 63/04

(57) ABSTRACT

An information processing system includes a first device, a second device, and a controller. The controller determines, prior to transmission of data from the first device to the second device, whether or not transmission of the data is permitted from an area security class based on a device attribute of the second device and from a data security class of the data, and outputs a determined result to the first device.

### CROSS-REFERENCE TO RELATED APPLICATIONS

This application is based on and claims priority under 35 USC 119 from Japanese Patent Application No. 2017-132937 filed Jul. 6, 2017.

### BACKGROUND

### (i) Technical Field

The present invention relates to an information processing system, an information processing apparatus, and a non-transitory computer readable medium.

### (ii) Related Art

How to ensure security in a teleworking environment such as working from home has been a great concern.

Technologies operated with a uniform security strength may impair a user's convenience and may not be compatible with the progress of a teleworking environment such as working from home in recent years.

### SUMMARY

According to an aspect of the invention, there is provided an information processing system including a first device, a second device, and a controller. The controller determines, prior to transmission of data from the first device to the second device, whether or not transmission of the data is permitted from an area security class based on a device attribute of the second device and from a data security class of the data, and outputs a determined result to the first device.

### BRIEF DESCRIPTION OF THE DRAWINGS

Exemplary embodiments of the present invention will be described in detail based on the following figures, wherein:

FIG. 1 is a system configuration diagram according to an exemplary embodiment;

FIGS. 2A to 2D are explanatory diagrams of different types of security classes, device levels, and area levels, respectively, according to the exemplary embodiment;

FIG. 3 is an explanatory diagram (part 1) illustrating the flow of data according to the exemplary embodiment;

FIG. 4 is an explanatory diagram (part 2) illustrating the flow of data according to the exemplary embodiment;

FIG. 5 is a flowchart illustrating a process performed by a personal computer (PC) according to the exemplary embodiment;

FIG. 6 is a flowchart illustrating a process performed by a transmission data censorship server according to the exemplary embodiment;

FIG. 7 is a flowchart illustrating a process performed by the transmission data censorship server according to another exemplary embodiment;

FIG. 8 is a flowchart illustrating a process performed by the transmission data censorship server according to yet another exemplary embodiment; and

FIG. 9 is a flowchart illustrating a process performed by the transmission data censorship server according to a further exemplary embodiment.

### DETAILED DESCRIPTION

Hereinafter, exemplary embodiments of the present invention will be described on the basis of the drawings.

### First Exemplary Embodiment

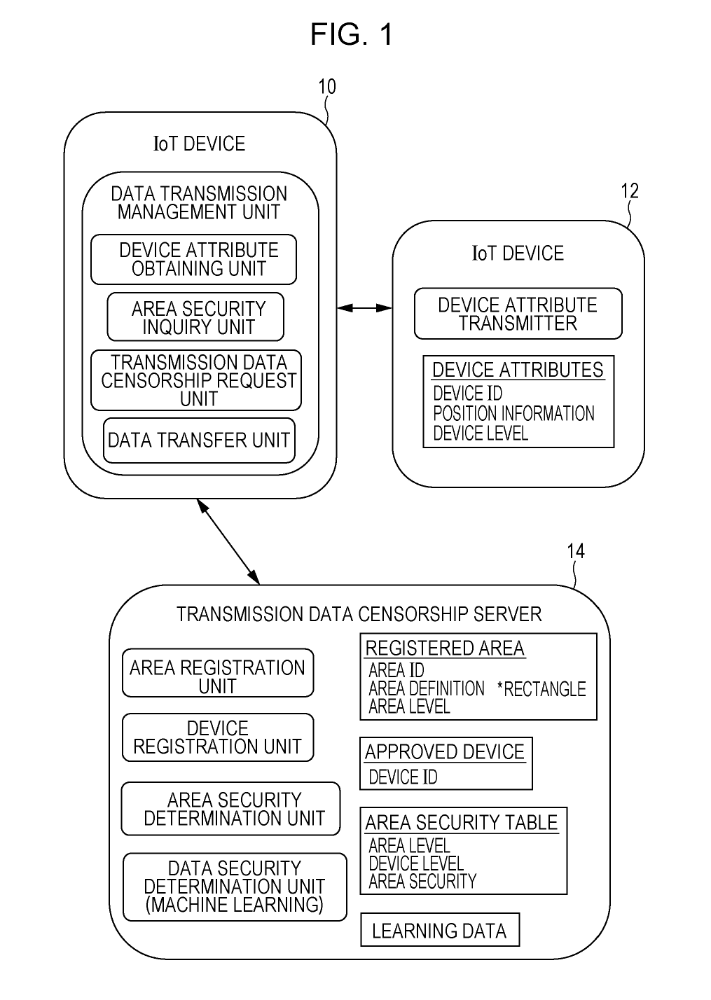

FIG. 1 is a system configuration diagram of an information processing system according to a first exemplary embodiment. The information processing system includes Internet of things (IoT) devices 10 and 12, and a transmission data censorship server 14. The IoT device 10 and the IoT device 12, and the IoT device 10 and the transmission data censorship server 14 are connected to each other by a communication line to be able to transmit/receive data. Although the communication line is preferably a wireless link, the communication line may be wired.

The IoT device 10 functions as a first device, and is a device such as a PC, a tablet, or a smartphone operated by a user. The IoT device 10 includes a data transmission management unit, which is a function module. The data transmission management unit includes a device attribute obtaining unit, an area security inquiry unit, a transmission data censorship request unit, and a data transfer unit. The IoT device 10 includes, specifically, one or more processors (hereinafter referred to as “processor(s)”), memory, a communication interface, an input/output interface, a display, and a position sensor. The processor(s) realizes the data transmission management unit by reading and executing a processing program stored in program memory.

That is, the processor(s) accepts a data transmission request for the IoT device 12 from a user via the input/output interface. As will be described later, when the IoT device 12 is a printer or an image forming apparatus (multifunctional peripheral) having multiple functions of a copy machine, a fax machine, a printer, and a scanner, the processor(s) accepts a print instruction for the image forming apparatus. The printer accesses the IoT device 12 via the communication interface, and obtains device attributes from the IoT device 12. In addition, when the processor(s) obtains device attributes from the IoT device 12, the processor(s) transmits the device attributes to the transmission data censorship server 14 and inquires about the area security. On receipt of a response of the area security class from the transmission data censorship server 14, the processor(s) transmits data to be transmitted to the IoT device 12, such as image data to be printed in the case of a print instruction from the user, to the transmission data censorship server 14 and requests censorship. On receipt of a response indicating that transmission is permitted from the transmission data censorship server 14, the processor(s) transmits transmission data permitted by the transmission data censorship server 14 to the IoT device 12, and executes a request from the user. That is, in the case where a request from the user is a print instruction, the processor(s) transmits image data to the IoT device 12 to be printed and output.

The IoT device 12 functions as a second device, and is a printer or an image forming apparatus that accepts an instruction from the IoT device 10 and executes a job. The IoT device 12 includes a device attribute transmitter, which is a function module. The IoT device 12 includes, specifically, one or more processors (hereinafter referred to as “processor(s)”), memory, a communication interface, an input/output interface, a display, and a position sensor. The processor(s) realizes the device attribute transmitter by reading and executing a processing program stored in program memory. That is, the processor(s) receives a device attribute obtaining request from the IoT device 10 via the communication interface, reads device attributes from the memory, and returns the device attributes to the IoT device 10. The device attributes include the device identification (ID), device level, and position information of the IoT device 12, and the position information is detected by the position sensor. The position sensor may be configurated by a global positioning system (GPS) sensor or the like.

The transmission data censorship server 14 determines whether or not transmission of data to be transmitted from the IoT device 10 to the IoT device 12 is permitted. The transmission data censorship server 14 includes an area registration unit, a device registration unit, an area security determination unit, and a data security determination unit, which are function modules. The transmission data censorship server 14 includes, specifically, one or more processors (hereinafter referred to as “processor(s)”), memory, a communication interface, an input/output interface, and a display. The processor(s) realizes the function modules by reading and executing a processing program stored in program memory.

That is, the processor(s) realizes the area registration unit by registering an area ID, an area definition (such as a rectangular area), and an area level in the memory in response to an instruction from an administrator. In addition, the processor(s) realizes the device registration unit by registering a device ID in the memory in response to an instruction from the administrator. More specifically, the user applies for an area ID and a device ID using mail, a web page, or the like, and the administrator checks the applicant (user) and the device ID from an area to be approved, and registers the device ID as an approved device in the memory. In addition, the processor(s) realizes the area security determination unit by determining the area security class in response to an inquiry from the IoT device 10. Here, the term “area security class” refers to the degree of security of the IoT device 12, which is defined on the basis of the type and position information of the IoT device 12. The area security class may be classified into one of multiple levels and may be evaluated. The processor(s) determines the area security class using a registered area, an approved device, and an area security table stored in the memory.

In addition, the processor(s) realizes the data security determination unit by determining the data security class of transmission data to be transmitted from the IoT device 10 to the IoT device 12 in response to a censorship request from the IoT device 10, and determining whether or not transmission is permitted by comparing the data security class of the transmission data and the area security class. Here, the term “data security class” refers to the degree of security of data, which is defined on the basis of the details (content) of that data. The data security class may also be classified into one of multiple levels and may be evaluated. A machine-learnt neural network or the like is used in determination of the data security class of transmission data.

The term “IoT device” in the first exemplary embodiment is an element of an Internet of Things (IoT), and may be defined as a device with a sensor and a communication function.

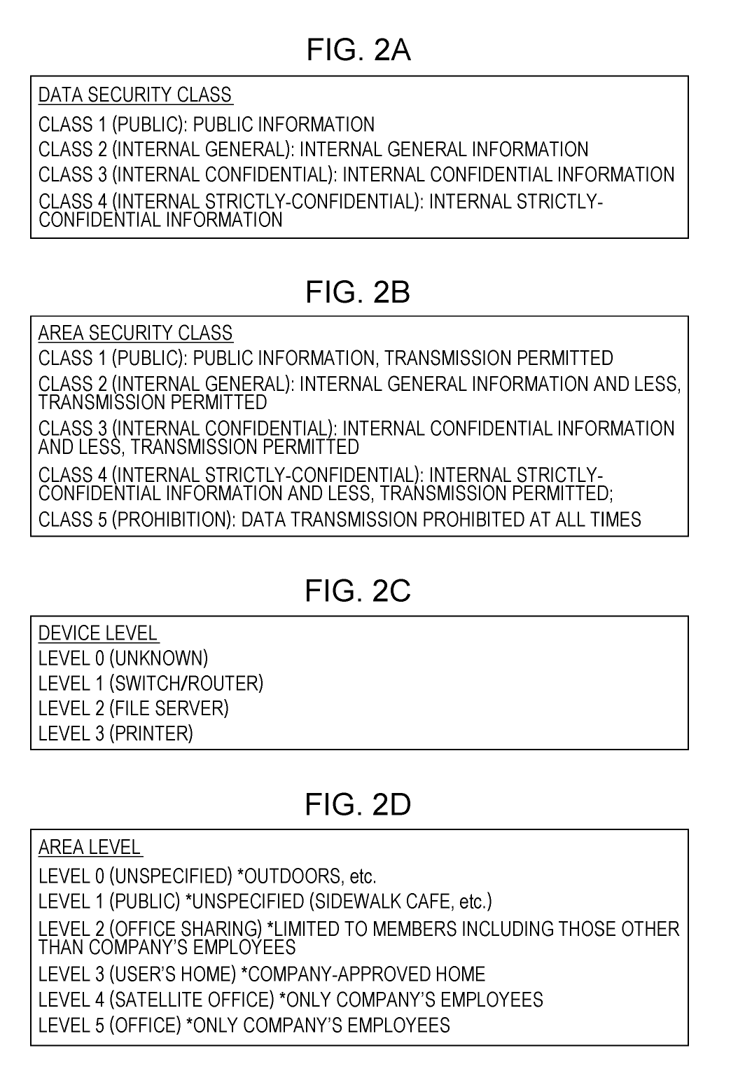

FIGS. 2A to 2D illustrate exemplary data security classes, area security classes, device levels, and area levels, respectively, used in the first exemplary embodiment.

The data security class is classified into one of the following classes:

class 1: public information;

class 2: internal general information;

class 3: internal confidential information; and

class 4: internal strictly-confidential information.

The area security class is classified into one of the following classes:

class 1: public information, transmission permitted;

class 2: internal general information and less, transmission permitted;

class 3: internal confidential information and less, transmission permitted;

class 4: internal strictly-confidential information and less, transmission permitted; and

class 5: data transmission prohibited at all times.

The device level is classified into one of the following levels:

level 0: unknown;

level 1: switch/router;

level 2: file server; and

level 3: printer.

The area level is classified into one of the following levels:

level 0: unspecified (outdoors, etc.);

level 1: public (unspecified sidewalk cafe, etc.);

level 2: office sharing (limited to members including those other than company's employees);

level 3: user's home (company-approved home);

level 4: satellite office (only company's employees); and

level 5: office (only company's employees).

The processor(s) of the transmission data censorship server 14 determines which of levels 0 to 3 the device level included in the device attributes received from the IoT device 10 is, and determines which of levels 0 to 5 the area level is from position information included in the device information. Using the area security table stored in the memory, the processor(s) determines the area security class corresponding to the device level and the area level. For example,

given the device level=level 0; and

the area level=level 0,

then, it is determined that

the area security class=class 1.

### Also,

given the device level=level 3; and

the area level=level 1,

then, it is determined that

the area security class=class 1.

### Furthermore,

given the device level=level 3; and

the area level=level 3,

then, it is determined that

the area security class=class 3.

Given a constant device level, the area security class may be determined in accordance with the area level. The higher the area level, the higher the area security level.

Hereinafter, a process according to the first exemplary embodiment will be described in detail using a PC as the IoT device 10 and a printer as the IoT device 12. The printer includes a multifunctional peripheral or an image forming apparatus.

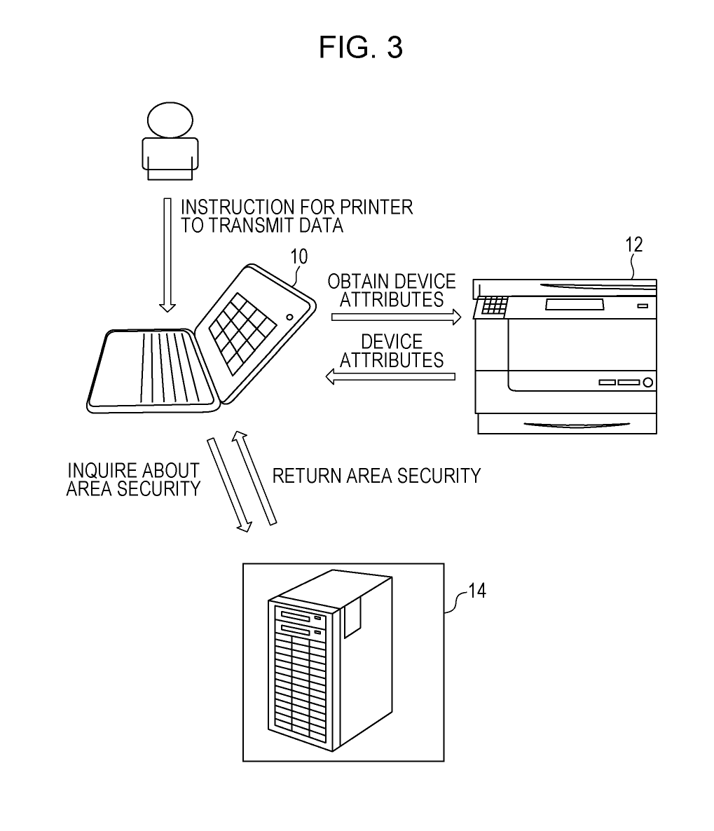

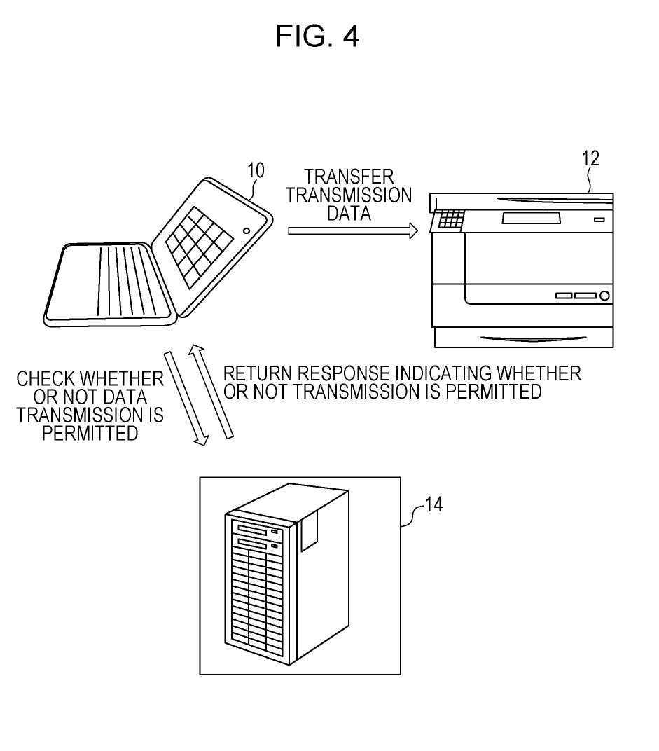

FIGS. 3 and 4 illustrate the flow of data according to the first exemplary embodiment.

As illustrated in FIG. 3, the user gives an instruction to print and output image data to the printer 12 by operating the PC 10.

Prior to transmission of image data, the processor(s) of the PC 10 requests the printer 12 for device attributes. In response to the request from the PC 10, the processor(s) of the printer 12 reads the device ID, device level, and position information stored in the memory, and transmits the read information as device attributes to the PC 10. The device ID is, for example, a Universally Unique Identifier (UUID). The device level is classified into one of levels 0 to 3 as illustrated in FIG. 2C. The device level of the printer 12 is level 3. The position information need not be stored in the memory. The processor(s) may obtain position information detected by the position sensor at a time point at which a request is received from the PC 10, and transmits the detected position information to the PC 10. When the PC 10 obtains device attributes from the printer 12, the PC 10 inquires of the transmission data censorship server 14 about the area security class along with the device attributes.

On receipt of the device attributes and the inquiry from the PC 10, the processor(s) of the transmission data censorship server 14 determines whether or not the device ID included in the device attributes matches an approved device ID registered in the memory. In the case where the device ID matches an approved device ID, further using the position information and the device level included in the device attributes, the processor(s) determines the area security class of the printer 12 by referring to the area security table stored in the memory, and returns the area security class to the PC 10.

Next, as illustrated in FIG. 4, on receipt of the area security class of the printer 12 from the transmission data censorship server 14, the processor(s) of the PC 10 transmits image data to be transmitted to the printer 12, along with the area security class, to the transmission data censorship server 14 and requests data transmission permission.

On receipt of the request from the PC 10, the transmission data censorship server 14 calculates the data security class of the image data, and compares the calculated data security class with the area security class of the printer 12. The data security class is calculated as one of classes 1 to 4, and the area security class is determined as one of classes 1 to 5. Therefore, the transmission data censorship server 14 determines whether or not the class level of the data security class is less than or equal to the class level of the area security class. That is, the transmission data censorship server 14 determines whether or not the following holds true:

data security class≤area security class. When the class level of the data security class is less than or equal to the class level of the area security class, the transmission data censorship server 14 determines that transmission of the image data is permitted since the security level of the image data does not exceed the security level of the printer 12 and it is thus safe to transmit the image data. In contrast, when the class level of the data security class exceeds the class level of the area security class, the transmission data censorship server 14 determines that transmission of the image data is prohibited since the security level of the printer 12 is insufficient and it is thus unsafe to transmit the image data. For example,

given the data security class=class 4; and

the area security class=class 4,

then, transmission is permitted. Also,

given the data security class=class 1; and

the area security class=class 3,

then, transmission is permitted. In contrast,

given the data security class=class 3; and

the area security class=class 2,

then, transmission is prohibited. In this manner, in the first exemplary embodiment, whether or not transmission is permitted is determined not merely by the area security level set in accordance with the position information of the printer 12, but in accordance with the relative relationship between the area security level and the security level of image data to be transmitted to the printer 12.

The processor(s) of the transmission data censorship server 14 may include a processing circuit that performs at least part of recognition processing based on learning information obtained by machine learning. The processing circuit includes multiple nodes and each edge connecting two nodes. The processing circuit performs recognition processing using learning data stored in the memory. Recognition processing performed by the processing circuit is, for example, neural network recognition processing, and learning data obtained by machine learning is the weight of each edge used in neural network recognition processing. The weight of each edge is read from the memory prior to recognition processing, and is set to each edge. The details of recognition processing change according to the weight. Neural network recognition processing may be deep learning recognition processing where elements of the processing circuit are arranged in a multilayer structure.

Machine learning using teacher data is known art. For example, in backpropagation, input data is input to a neural network to be learned, and an output at that time is obtained. Regarding an output node, the difference between an output value and an ideal value is calculated, and, among edges of one previous layer, the weight of an edge with the greatest weight is adjusted to approach the ideal value. A similar adjustment is performed for edges of a further previous layer, thereby propagating the weight adjustment from the output layer to the input layer. The weight of each edge is adjusted by repeating such adjustments on a vast amount of teacher data, that is, image data labeled with a known data security class. Examples of neural networks include convolutional neural networks (CNN) and recurrent neural networks (RNN). Examples of machine learning methods include a boosting method and a support vector machine (SVM) method.

The processor(s) of the transmission data censorship server 14 may calculate the data security class of image data using a different method. For example, the processor(s) extracts words by performing lexical analysis of characters included in the received image data, and calculates the frequency of appearance of each of the extracted words by counting the number of appearances of each word. The processor(s) calculates the importance of each word by normalizing the frequency of appearance of each word using the probability of appearance in other image data which has been calculated in advance, and calculates the data security class by comparing the calculated importance of each word with a set of the importance of image data whose data security class is known, which has been stored in advance in the memory.

When image data includes words like “for internal use only”, “confidential”, and “secret”, needless to say, the data security class may be determined on the basis of these words. When information regarding the secrecy level of image data is embedded as meta data of the image data, the data security class may be determined using these items of information.

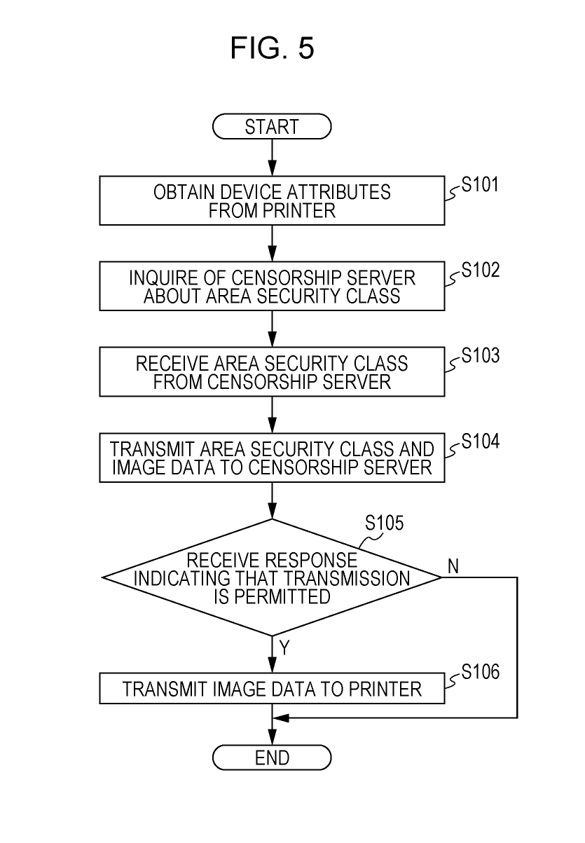

FIG. 5 is a flowchart illustrating a process performed by the PC 10 according to the first exemplary embodiment.

Upon acceptance of a print instruction from the user, the processor(s) of the PC 10 obtains device attributes from the printer 12 (S101). When the processor(s) of the PC 10 has similarly accepted a print instruction from the user in the past, obtained device attributes from the printer 12, and stored the device attributes in the memory, the processor(s) need not obtain device attributes from the printer 12 again. That is, upon acceptance of a print instruction, the processor(s) of the PC 10 determines whether or not device attributes of the printer 12 are stored in the memory, and, when device attributes are not stored in the memory, the processor(s) obtains device attributes from the printer 12 and stores the device attributes in the memory. The device attributes of the printer 12 specifically include a device ID, position information, and a device level.

Next, the processor(s) of the PC 10 transmits the device attributes of the printer 12 to the transmission data censorship server 14 and inquires of the transmission data censorship server 14 about the area security class (S102). At this time, the processor(s) of the PC 10 may transmit the device ID and position information of the PC 10 to the transmission data censorship server 14.

Next, on receipt of the area security class from the transmission data censorship server 14 (S103), the processor(s) of the PC 10 transmits image data to be transmitted to the printer 12, for which the print instruction has been received, and the area security class to the transmission data censorship server 14 and requests censorship (S104). Because the transmission data censorship server 14 stores the determined area security class in association with the PC 10 and the printer 12 in the memory, the processor(s) of the PC 10 may only transmit the image data to the transmission data censorship server 14 and request censorship.

Next, the processor(s) of the PC 10 receives the censorship result from the transmission data censorship server 14, and determines whether or not the result indicates that transmission is permitted (S105). When transmission is permitted, the processor(s) of the PC 10 transmits the image data to the printer 12, and causes the printer 12 to execute a print job (S106). When transmission is prohibited, the processor(s) of the PC 10 does not transmit the image data to the printer 12.

When the processor(s) of the PC 10 does not transmit the image data to the printer 12, the processor(s) may display a message such as “Printing is not executable because there is a security problem” on the display to inform the user.

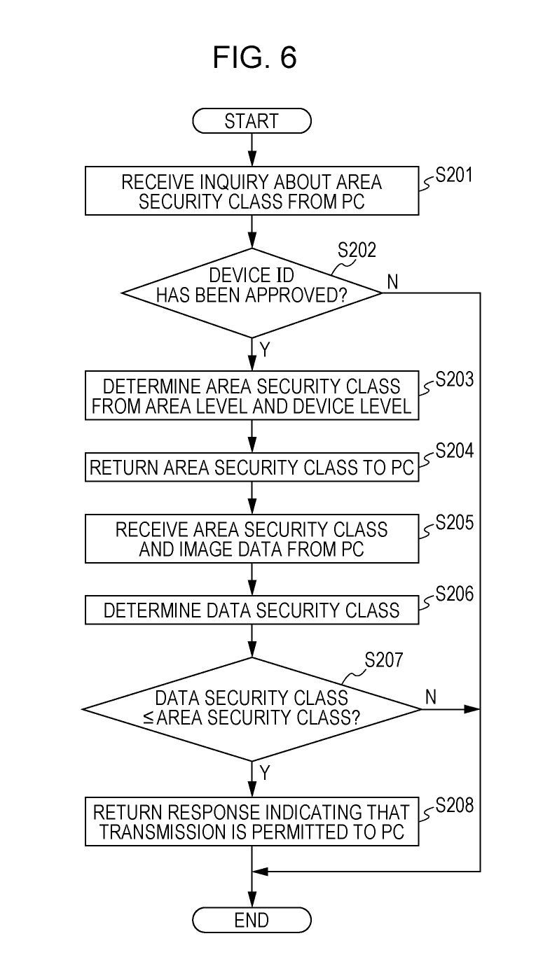

FIG. 6 is a flowchart illustrating a process performed by the transmission data censorship server 14 according to the first exemplary embodiment.

On receipt of the device attributes and the inquiry about the area security class from the PC 10 (S201), the processor(s) of the transmission data censorship server 14 extracts a device ID included in the device attributes and determines whether or not the extracted device ID matches an approved device ID registered in the memory (S202). When the device ID has not been approved (NO in S202), the process ends without determining the area security class. The processor(s) may return to the PC 10 that the device ID of the printer 12 has not been approved. In this case, because the area security class has not been determined yet, although transmission is permitted, the image data is not transmitted to the PC 10, and no printing is performed by the printer 12.

When the device ID matches an approved device ID (YES in S202), the processor(s) determines the area level from position information included in the device attributes, and determines the area security class along with a device level included in the device attributes (S203). The area security class is determined from five levels, namely, class 1 to class 5, as illustrated in FIG. 2B. Class 5 is a class where no security is ensured at all and data transmission is prohibited at all times. The area security class may be determined as class 5 when, for example, confidential information has leaked from the corresponding printer in the past, or the probability of information leakage is high due to some causes. When an error occurs in the printer 12 and the error information is stored in the memory of the transmission data censorship server 14, the area security class may be determined as class 5.

When the processor(s) determines the area security class of the printer 12 using the device attributes, the processor(s) transmits the area security class to the PC 10 as a response to the inquiry (S204).

Next, on receipt of the image data, area security class, and censorship request from the PC 10 (S205), the processor(s) determines the data security class of the image data using the above-described neural network or the like (S206), and compares the data security class of the image data with the area security class of the printer 12 (S207). When the comparison result is that

data security class area security class,

the processor(s) determines that the security level of the printer 12 is sufficient for the security level of the image data, and returns to the PC 10 that transmission is permitted (S208). In contrast, when the comparison result is that

data security class>area security class,

the processor(s) determines that the security level of the printer 12 is insufficient for the security level of the image data and it is thus not safe to transmit the image data, and does not return to the PC 10 that transmission is permitted. Here, a process of not returning to the PC 10 that transmission is permitted may include a process of returning to the PC 10 that transmission is prohibited.

When the area security class is class 5, the response indicating that transmission is permitted is not returned to the PC 10 without comparing the data security class and the area security class.

As has been described above, in the first exemplary embodiment, because whether or not transmission of image data is permitted, that is, whether or not printing with the printer 12 is permitted, is determined on the basis of the relative relationship between the data security class of the image data and the area security class of the printer 12, the user's convenience may be secured while ensuring security, compared with the case of uniformly determining whether or not printing is permitted in accordance with the security strength of the printer 12. That is, even when the security class of the printer 12 itself is low, if the security class of the image data is low enough to match the security class of the printer 12, printing is permitted. In this way, the user's convenience may be improved.

### Second Exemplary Embodiment

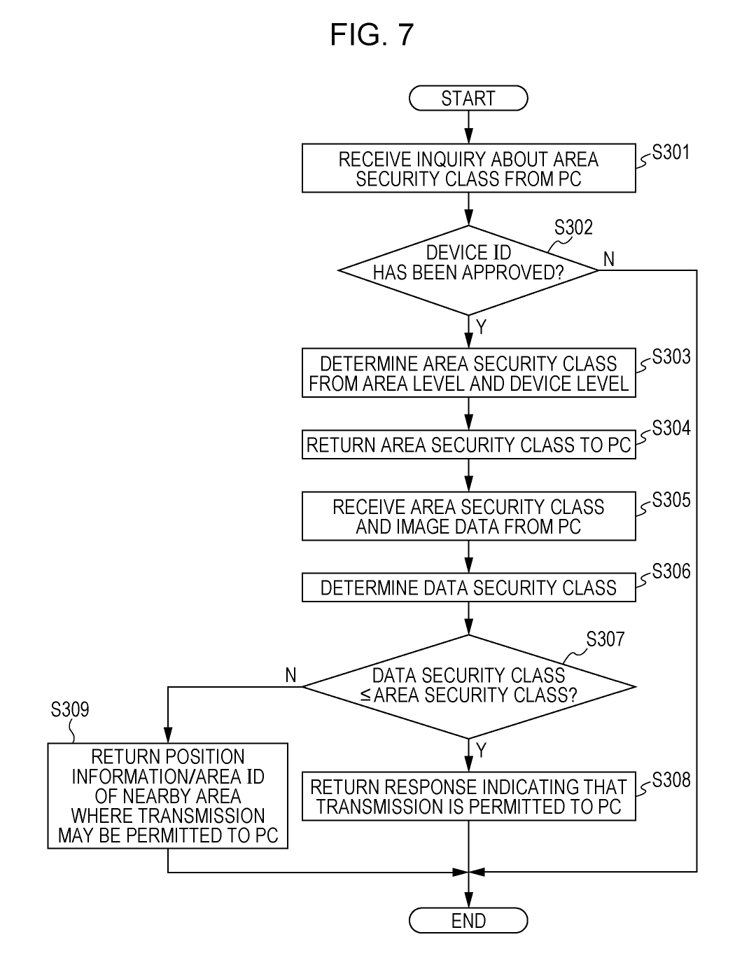

FIG. 7 is a flowchart illustrating a process performed by the transmission data censorship server 14 according to a second exemplary embodiment. The processing in steps S301 to S308 is the same as the processing in steps S201 to S208 illustrated in FIG. 6.

In the case of the following:

data security class>area security class,

(NO in S307), the processor(s) of the transmission data censorship server 14 returns to the PC 10 the position information/area ID of a nearby area where transmission may be permitted by taking into consideration the data security class of the image data (S309). Instead of the information/area ID of the nearby area, the processor(s) may return the device ID of a device positioned nearby. The position information/area ID of a nearby area where transmission may be permitted or the device ID is determined on the basis of the position information transmitted from the PC 10 or from device IDs registered in the memory. For example, when, as a result of a print instruction given from the PC 10 or another PC to another printer in the past, the area security class of this other printer has been determined and stored in the memory, the processor(s) compares the position information of the PC 10 with the area security class of this other printer.

The processor(s) checks position information of this other printer satisfying the following:

data security class area security class,

and, when it is determined that this other printer is near the PC 10, the processor(s) returns the device ID of this other printer to the PC 10.

The processor(s) of the PC 10 displays the position information/area ID or the device ID received from the transmission data censorship server 14 on the display to inform the user, transmits the image data to this other printer on the basis of an instruction from the user, and causes this other printer to execute a print job.

### Third Exemplary Embodiment

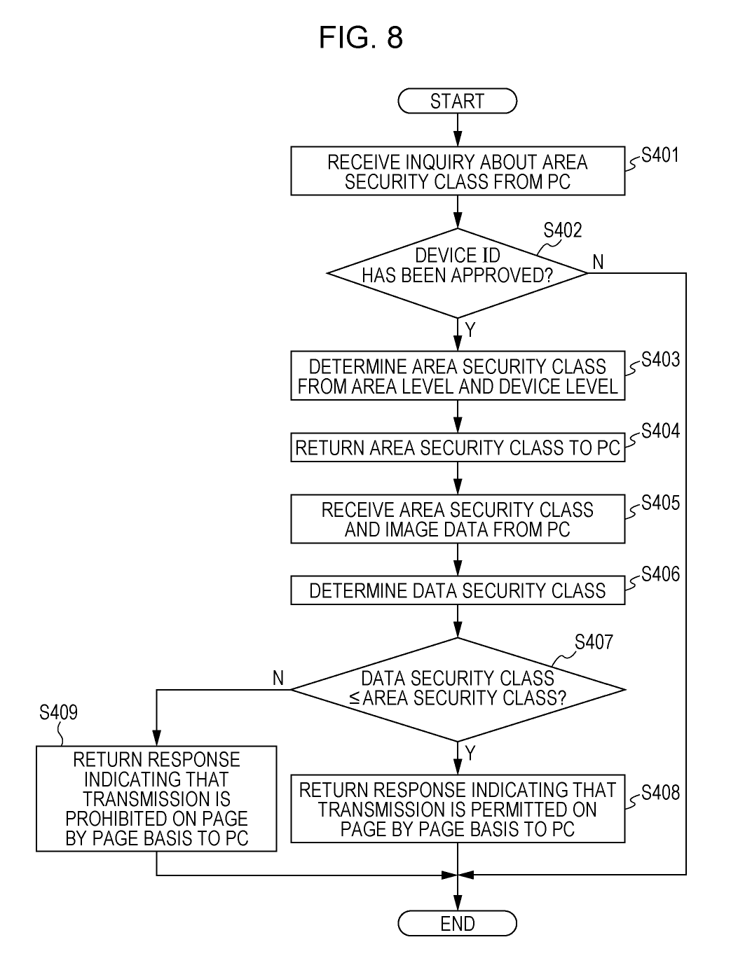

FIG. 8 is a flowchart illustrating a process performed by the transmission data censorship server 14 according to a third exemplary embodiment. The processing in steps S401 to S407 is the same as the processing in steps S201 to S207 illustrated in FIG. 6. In the processing in step S406, the data security class of the image data is determined on a page by page basis; and, in step S407, the data security class of the image data and the area security class are compared to each other on a page by page basis. Whether or not transmission is permitted is returned on a page by page basis to the PC 10 (S408 and S409). As a result, when the image data has, for example, three pages, and when it is determined as follows:

the first page: data security class area security class,

the second page: data security class area security class, and

the third page: data security class>area security class,

then, the following is returned to the PC 10:

the first page: transmission is permitted;

the second page: transmission is permitted; and

the third page: transmission is prohibited.

In this case, the PC 10 transmits only the first page and the second page as the image data to the printer 12, and causes the printer 12 to execute a print job. Because it is determined that transmission of the third page is prohibited, the third page is not transmitted to the printer 12, and the third page is not printed.

For the third page, like the second exemplary embodiment, the position information/area ID of a nearby area of the PC 10, which may be capable of printing the third page, or the device ID may be returned to the PC 10.

Instead of a page by page basis, the data security class may be determined in arbitrary units, such as in units of paragraphs, and may be compared with the area security class.

### Fourth Exemplary Embodiment

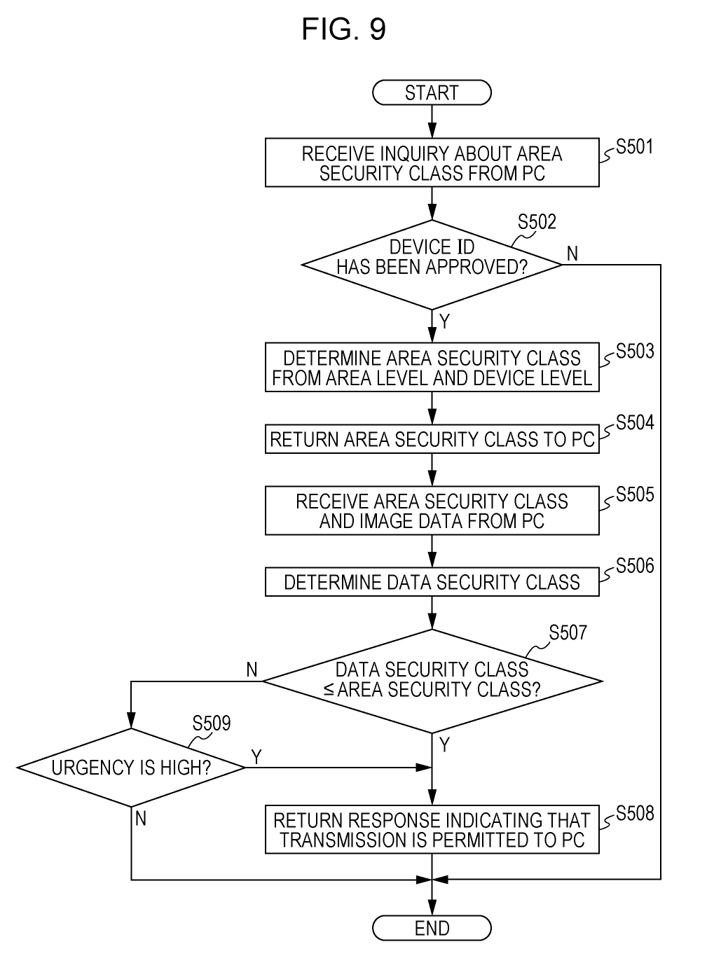

FIG. 9 is a flowchart illustrating a process performed by the transmission data censorship server 14 according to a fourth exemplary embodiment. The processing in steps S501 to S508 is the same as the processing in steps S201 to S208 illustrated in FIG. 6.

In the case of the following:

data security class>area security class,

(NO in S507), the processor(s) of the transmission data censorship server 14 further determines the urgency of the image data (S509). The urgency of the image data is requested by adding urgency information when, for example, requesting censorship from the PC 10 along with the image data. In the case where, for example, the user wants to urgently print and output the image data, the user selects and operates a particular button or menu of the PC 10. The processor(s) of the PC 10 adds information indicating that the urgency is high to the image data, and transmits the image data with the urgency information to the transmission data censorship server 14.

When the urgency of the image data is high (S509), the processor(s) of the transmission data censorship server 14 returns that, taking into consideration the user's convenience, transmission is permitted even when the data security class exceeds the area security class. When the urgency of the image data is low, the processor(s) of the transmission data censorship server 14 does not return that transmission is permitted, as in FIG. 6.

Although the exemplary embodiments of the present invention have been described above, the present invention is not limited to these exemplary embodiments, and various modifications are possible. Hereinafter, modifications will be described.

### First Modification

Although the PC 10 obtains device attributes from the printer 12 and the device attributes include a device level in the exemplary embodiments, the PC 10 may obtain, instead of the device level, firmware information (such as version information) of the printer 12 as a device attribute, and may transmit the firmware information to the transmission data censorship server 14. The processor(s) of the transmission data censorship server 14 may determine the device level from the firmware information, and may determine the area security class using the device level. When it is determined as follows:

data security class>area security class

by comparing the above-determined area security class with the data security class, the processor(s) of the transmission data censorship server 14 may return appropriate firmware information to the PC 10 to enable updating of the firmware of the printer 12. Alternatively, the transmission data censorship server 14 may supply appropriate firmware to the printer 12 to update the firmware.

### Second Modification

Although the processor(s) of the transmission data censorship server 14 determines whether or not transmission of image data to the printer 12 is permitted in response to a censorship request from the PC 10 and returns the determination result to the PC 10 in the exemplary embodiments, the processor(s) may not only determine whether or not transmission of image data is permitted, but also determine whether or not usage (browsing, for example) of the data on the PC 10 is permitted. Whether or not browsing of the data is permitted may be determined by comparing a user privilege identified from the user ID of the user or the like with the data security class of the data of interest. Accordingly, it may be possible to return, for example, that transmission of the data to the printer 12 is prohibited although browsing of the data is permitted.

### Third Modification

Although the transmission data censorship server 14 determines the area security class and the data security class in the exemplary embodiments, the transmission data censorship server 14 may be realized as a multifunctional peripheral or an image forming apparatus that implements multiple functions of a copy machine, a fax machine, a printer, a scanner, and the like.

At least one of determination of the area security class, determination of the data security class, and determination of whether or not transmission is permitted may be executed by the PC 10. Specifically, any of the following configurations is possible:

(1) Only the area security class is determined by the PC 10;
(2) Only the data security class is determined by the PC 10;
(3) The area security class, the data security class, and whether or not transmission is permitted are determined by the PC 10; and
(4) The area security class and the data security class are determined by the transmission data censorship server 14, and whether or not transmission is permitted is determined by the PC 10.

In the case of (1) described above, the transmission data censorship server 14 determines the data security class, and the PC 10 or the transmission data censorship server 14 determines whether or not transmission is permitted.

In the case of (2) described above, the transmission data censorship server 14 determines the area security class, and the PC 10 or the transmission data censorship server 14 determines whether or not transmission is permitted.

In the case of (3) described above, the transmission data censorship server 14 becomes unnecessary, and the PC 10 may function as both the IoT device 10 and the transmission data censorship server 14.

In the case of (4) described above, the result of determining whether or not transmission is permitted may be transmitted from the PC 10 to the transmission data censorship server 14.

### Fourth Modification

Although the processors and processing programs implement a neural network in the exemplary embodiments, a neural network may be implemented by dedicated hardware (application specific integrated circuit (ASIC)) or using a field-programmable gate array (FPGA). In the case of using an FPGA, part of a neural network may be implemented by software, or may be implemented as a complex of hardware and software. The processors may be central processing units (CPUs) or graphics processing units (GPUs). The same applies to the case where the PC 10 implements a neural network.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system comprising:
a first device;
a second device; and
a controller that determines, prior to transmission of data from the first device to the second device, whether or not transmission of the data is permitted from an area security class based on a device attribute of the second device and from a data security class of the data, and outputs a determined result to the first device.

2. The information processing system according to claim 1, wherein the controller outputs that transmission of the data is permitted when the data security class is lower than or equal to the area security class.

3. The information processing system according to claim 2, wherein the controller outputs that transmission of the data is prohibited when the data security class exceeds the area security class.

4. The information processing system according to claim 2, wherein the controller outputs device information based on which the data security class is lower than or equal to the area security class when the data security class exceeds the area security class.

5. The information processing system according to claim 2, wherein, even when the data security class exceeds the area security class, the controller outputs that transmission of the data is permitted when urgency of the data is high.

6. The information processing system according to claim 1, wherein the device attribute includes a type and position information of the second device.

7. The information processing system according to claim 6, wherein the controller determines the area security class of the second device by referring to a table that defines in advance a corresponding relationship between the type and position information of the second device and the area security class.

8. The information processing system according to claim 6, wherein the controller determines the data security class using a machine-learnt neural network.

9. The information processing system according to claim 1, wherein:
the second device is a printer; and
the data is image data to be processed by the printer.

10. The information processing system according to claim 9, wherein the controller determines whether transmission of the image data is permitted on a page by page basis and outputs a determined result.

11. An information processing apparatus comprising:
an input unit that accepts an instruction to transmit data; and
a controller that obtains, prior to transmission of the data, a device attribute of a transmission destination of the data, and determines whether or not transmission of the data is permitted by comparing an area security class based on the device attribute and a data security class of the data.

12. A non-transitory computer readable medium storing a program causing a computer to execute a process, the process comprising:
accepting an instruction to transmit data;
obtaining a device attribute of a transmission destination of the data prior to transmission of the data;
determining an area security class of the transmission destination of the data on the basis of the device attribute;
determining a data security class of the data; and
determining whether or not transmission of the data is permitted by comparing the area security class and the data security class and outputting a determined result.
